(19) United States
(12) Patent Application Publication
(10) Pub. No.: US 2013/0181958 A1
(43) Pub. Date: Jul. 18, 2013

(54) DISPLAY SYSTEM AND METHOD FOR ADJUSTING BRIGHTNESS OF DISPLAY DEVICE

(71) Applicants: Chi-Chih WANG, Tu-Cheng (TW); Tzu-Te WANG, Tu-Cheng (TW); Xiao CAI, Shenzhen City (CN)

(72) Inventors: Chi-Chih WANG, Tu-Cheng (TW); Tzu-Te WANG, Tu-Cheng (TW); Xiao CAI, Shenzhen City (CN)

(21) Appl. No.: 13/662,101

(22) Filed: Oct. 26, 2012

(30) Foreign Application Priority Data
Jan. 13, 2012 (CN) 201210009790.0

(51) Int. Cl. G09G 5/10

(52) U.S. Cl. 345/207

(57) ABSTRACT

A display system includes a display device, a solar panel, a voltage reader, a processor and a brightness control unit. The solar panel generates a voltage according to an intensity of sunlight. The voltage reader receives the voltage from the solar panel and transfers to the processor. The processor receives the voltage of the voltage reader and generates a control signal according to the voltage of the voltage reader. The brightness control unit receives the control signal and adjusts the brightness of the display device according to the control signal.

### BACKGROUND

1. Technical Field

The disclosure generally relates to a display system and a method for adjusting brightness of a display device.

2. Description of Related Art

Nowadays, display panels have been widely used in billboards and advertisements to display kinds of information. However, a display panel is easily affected by outer environment. For example, when the sunlight has a relatively high intensity, the brightness of the display panel may be not enough to clearly show the content of the display panel. When the sunlight has a relatively low intensity, the display panel may be too bright for the audiences, and wasting the electric power.

What is needed, therefore, is a displayer system and a method for adjusting brightness of a display device which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a display system in accordance with one embodiment of the disclosure.

FIG. 2 is a schematic view showing an operation process of the display system of FIG. 1.

FIG. 3 is a schematic view showing another operation process of the display system of FIG. 1.

### DETAILED DESCRIPTION

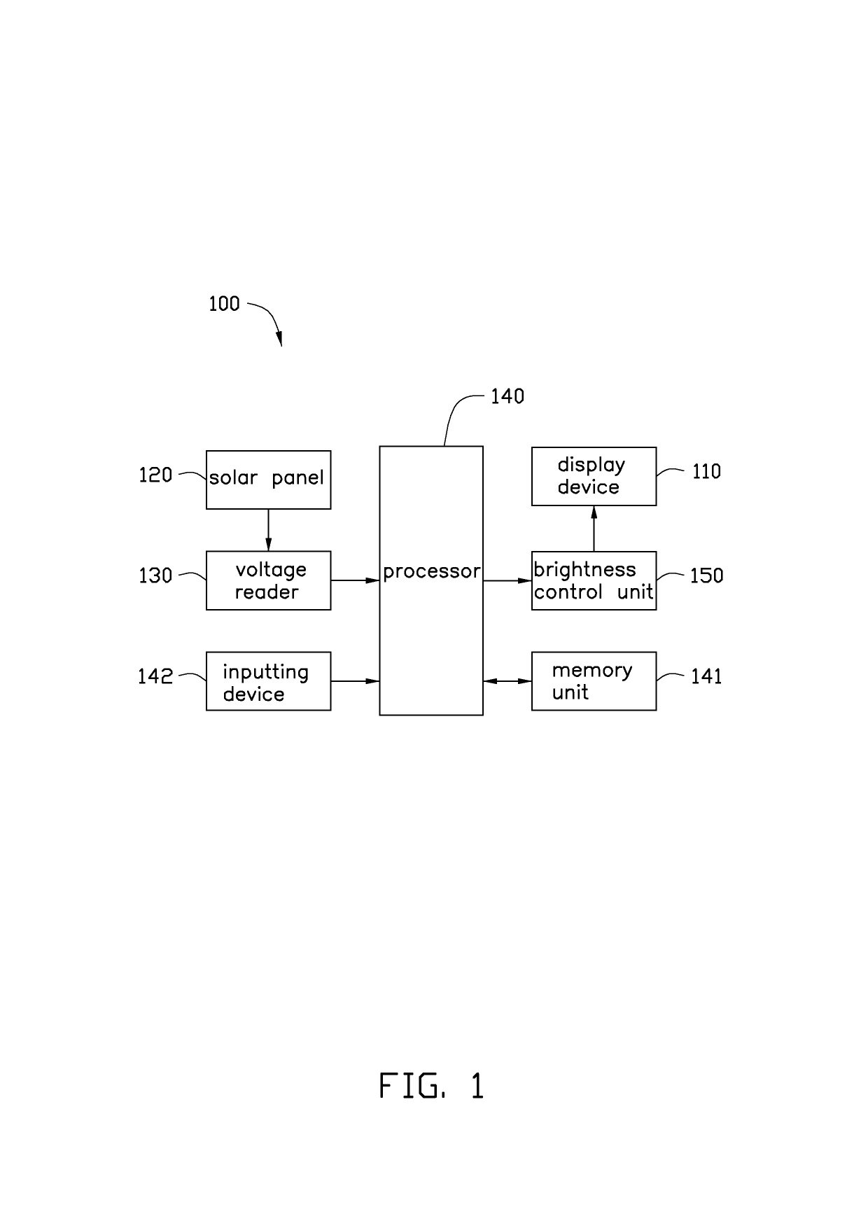

Referring to FIG. 1, a display system 100 in accordance with one embodiment of the disclosure is shown. The display system 100 includes a display device 110, a solar panel 120, a voltage reader 130, a processor 140 and a brightness control unit 150.

The display device 110 can be a liquid crystal display or an LED display. The display device 110 is configured to display all kinds of information such as the weather, the traffic condition or the map data.

The solar panel 120 receives the sunlight to generate a DC (direct current) voltage.

The voltage reader 130 is electrically connected with the solar panel 120 and receives the DC voltage of the solar panel 120. In this embodiment, the voltage reader 130 transfers the DC voltage of the solar panel 120 to a DC voltage indicated by a digital signal and transmits it to the processor 140.

The processor 140 is electrically connected with the voltage reader 130 and receives the DC voltage from the voltage reader 130 indicated by a digital signal. The processor 140 generates a control signal according to the DC voltage. In this embodiment, the processor 140 further includes a memory unit 141. The memory unit 141 stores a plurality of voltage ranges and a plurality of control signals therein. Each of the voltage ranges is corresponding to one of the control signals. For example, the memory unit 141 has three voltage ranges (0-1V), (1V-2V) and (2V-3V). The three voltage ranges (0-1V), (1V-2V) and (2V-3V) are corresponding to a first control signal, a second control signal and a third control signal respectively. When the processor 140 receives a DC voltage, i.e. 2.5V, from the voltage reader 130, the processor 140 firstly determines the DC voltage is in which one of the voltage ranges. That is, the DC voltage of 2.5V is in the voltage range of (2V-3V). Therefore, the processor 140 will control the third control signal at the outputting terminal Preferably, the processor 140 further includes an inputting device 142. Users can input different voltage ranges and the corresponding control signals by the inputting device 142.

The brightness control unit 150 is electrically connected with the processor 140. The brightness control unit 150 adjusts the brightness of the display device 110 according to the control signal from the processor 140.

In this embodiment, the processor 140 output different control signals to the brightness control unit 150, thereby decreasing the brightness of the display device 110. For example, when the sunlight has a relatively high intensity, the solar panel 120 may output a DC voltage about 3V. In this time, the processor 140 will output the third control signal according to the DC voltage about 3V. Therefore, the display device 110 will has relatively high brightness to make the audiences to see the content of the display devices 110 clearly. When the intensity of the sunlight decreases, the DC voltage of the solar panel decreases accordingly, for example, decreases to 2V. The processor 140 will output the second control signal according to the DC voltage about 2V, therefore decreasing the brightness of the display device 110. When the intensity of the sunlight further decreases, the DC voltage of the solar panel 120 further decrease to 1V. The processor 140 will output the first control signal according to the DC voltage about 1V, therefore further decreasing the brightness of the display device 110.

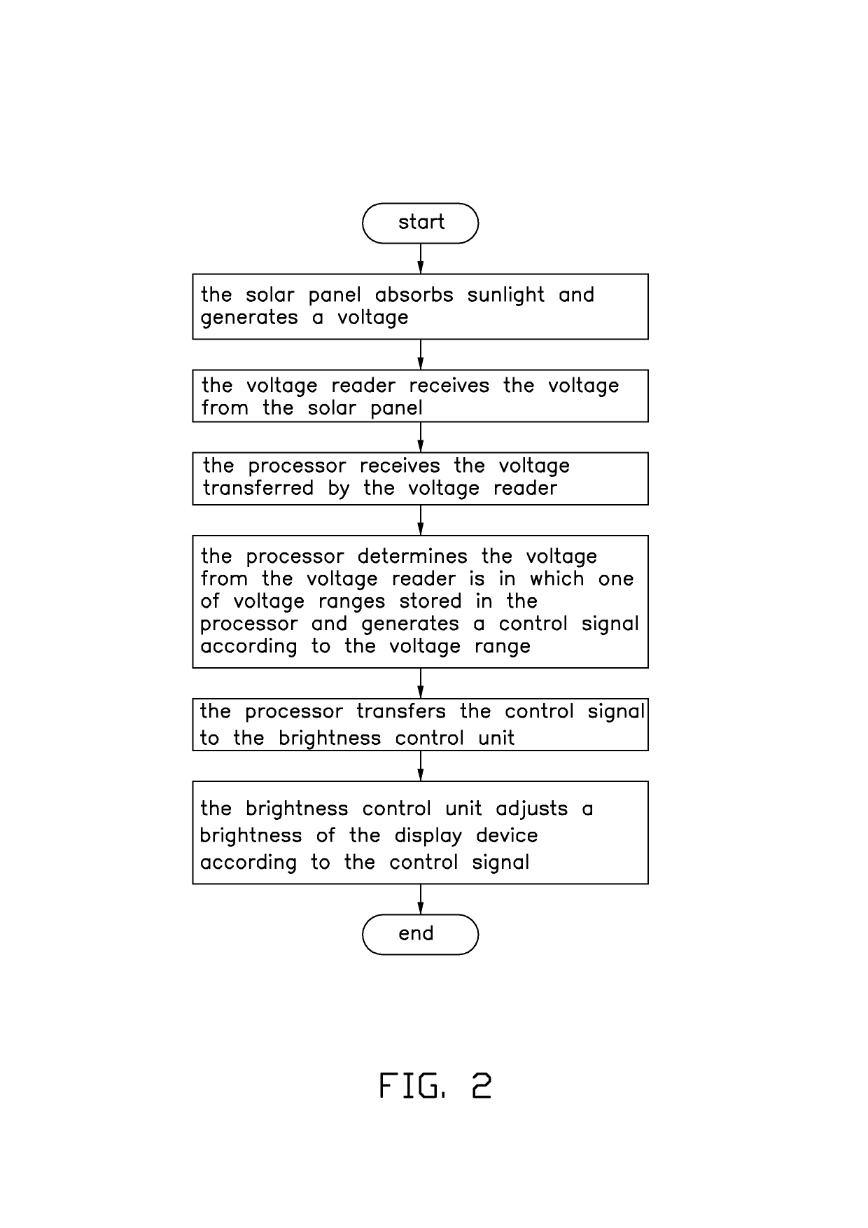

Referring to FIG. 2, the display system 100 is operating in the following steps.

In a first step, the display system 100 is started.

In a second step, the solar panel 120 receives the sunlight to generate a voltage.

In a third step, the voltage reader 130 receives the voltage from the solar panel 120.

In a four step, the processor 140 receives the voltage transferred by the voltage reader 130.

In a fifth step, the processor 140 determines the voltage from the voltage reader 130 is in which one of the voltage ranges stored in the processor 140, and generates a control signal according to the voltage range.

In the sixth step, the processor 140 transfers the control signal the brightness control unit 150.

In the seventh step, the brightness control unit 150 adjusts the brightness of the display device 110 according to the control signal.

In the eighth step, the adjusting process is ended.

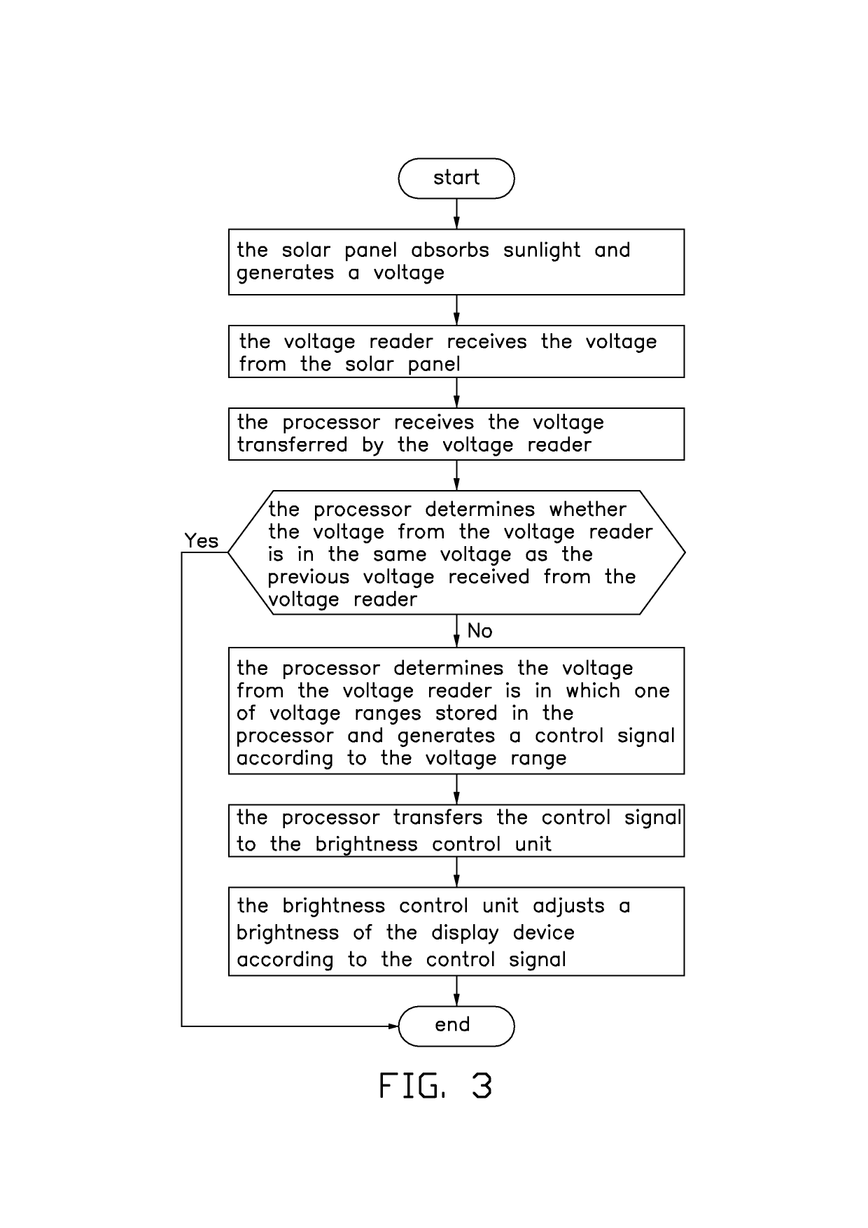

The operation of the display system 100 described above can be operated in circle. A time interval between each one of the operation can be determined by the users. In an alternatively embodiment, a determining process can be added between the fourth step and the fifth step. Referring to FIG. 3, the processor 140 firstly determines whether the voltage from the voltage reader 130 is in the same voltage range as the previous voltage received from the voltage reader 130. If the answer is “YES”, the adjusting process is ended and does not change the brightness of the display device 110. If the answer is “NO”, the fifth step to the seventh step is continued until end.

In the display system 100 described above, the solar panel 120 receives the sunlight and generates a DC voltage. The voltage reader 130 receives the DC voltage and transfers the DC voltage to the processor 140. The processor 140 generates a control signal according to the value of the DC voltage to control brightness of the display device 110. Therefore, the display system 100 can control the brightness of the display device 110 according to intensity of the sunlight.

A method for adjusting a brightness of a display device is also provided. The method includes following steps.

A display device 110 is provided to display all kinds of information. The display device 110 can be liquid crystal display or LED display.

A solar panel 120 is provided. The solar panel 120 generates a DC voltage according to the intensity of the sunlight.

A voltage reader 130 is provided to receive the DC voltage of the solar panel 120.

A processor 140 is provided to receive the voltage of the voltage reader 130. The processor 140 generates a control signal according to the DC voltage of the voltage reader 130. The processor 140 further includes a memory unit 141. The memory unit 141 stores a plurality of voltage ranges and a plurality of control signals. Each of the voltage range is corresponding to one of the control signal. Preferably, the processor 140 further includes an inputting device 142. Users can input the voltage ranges and the corresponding control signal by the inputting device 142.

A brightness control device 150 is provided. The brightness control device 150 receives the control signal and adjusts the brightness of the display device 110 according to the control signal.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A display system, comprising:
a display device to display information;
a solar panel to generate a voltage according to an intensity of sunlight;
a voltage reader, electrically connected with the solar panel to receive the voltage from the solar panel;
a processor, electrically connected with the voltage reader to receive the voltage of the voltage reader, and generating a control signal according to the voltage of the voltage reader; and
a brightness control unit, electrically connected with the processor, the brightness control unit receiving the control signal and adjusting the brightness of the display device according to the control signal.

2. The display system of claim 1, wherein the brightness of the display device decreases according to decreasing of the intensity of sunlight.

3. The display system of claim 1, wherein the display device can be selected from liquid crystal display or LED display.

4. The display system of claim 1, wherein the processor comprises a memory unit, the memory unit stores a plurality of voltage ranges and a plurality of control signals, and each of the voltage range is corresponding to the control signal.

5. The display system of claim 4, wherein the processor comprises an inputting device, users input the voltage ranges and the control signals by the inputting device.

6. A method for adjusting brightness of a display device, comprising following steps:
providing a display device to display information;
providing a solar panel to generate a voltage according to an intensity of sunlight;
providing a voltage reader, which is electrically connected with the solar panel to receive the voltage from the solar panel;
providing a processor, which is electrically connected with the voltage reader to receive the voltage of the voltage reader, and generating a control signal according to the voltage of the voltage reader; and
providing a brightness control unit, which is electrically connected with the processor, the brightness control unit receiving the control signal and adjusting the brightness of the display device according to the control signal.

7. The method of claim 6, wherein the brightness of the display device decreases according to decreasing of the intensity of sunlight.

8. The method of claim 6, wherein the display device can be selected from liquid crystal display or LED display.

9. The method of claim 6, wherein the processor comprises a memory unit, the memory unit stores a plurality of voltage ranges and a plurality of control signals, each of the voltage range is corresponding to the control signal.

10. The method of claim 9, wherein the processor comprises an inputting device, users input the voltage ranges and the control signals by the inputting device.
